(19) United States
(12) Patent Application Publication
(10) Pub. No.: US 2007/0236677 A1
(43) Pub. Date: Oct. 11, 2007

(54) Geo-location with laser and sensor system

(75) Inventors: Brian VanVoorst, Minneapolis, MN (US); Jathan W. Manley, Blaine, MN (US); Vicraj T. Thomas, Golden Valley, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/209,423

(22) Filed: Aug. 23, 2005

(51) Int. Cl. G01C 3/08; G01B 11/14

(52) U.S. Cl. 356/3.1; 356/623

(57) ABSTRACT

Methods and apparatus for determining geo-locations. The geo-location system of one embodiment includes two or more angle determination devices and a location determination device. Each angle determination device is mounted on top of a tower. The towers are positioned a distance from each other. Each angle determination device is adapted to automatically determine the angle of incident of a received signal and transmit a determined angle signal containing the determined angle. The location determination device is adapted to automatically use spatial triangulation techniques on received determined angle signals to provide location information.

### TECHNICAL FIELD

The present invention relates generally to location determinations and in particular to determining locations without existing GPS infrastructure.

### BACKGROUND

Determining the exact location of an object or person can be easily accomplished with global positioning satellites (GPS). However, when there is no exiting infrastructure (e.g. GPS) determining the exact location can be difficult. For example, in further missions to the moon or mars where no GPS system exists, the determination of location will be difficult.

For the reasons stated above and for other reasons stated below which will become apparent to those skilled in the art upon reading and understanding the present specification, there is a need in the art for an incrementally and quickly deployable infrastructure to provide geo-location information.

### SUMMARY OF INVENTION

The above-mentioned problems of current systems are addressed by embodiments of the present invention and will be understood by reading and studying the following specification.

In one embodiment, a geo-location system is provided. The geo-location system includes two or more angle determination devices and a location determination device. Each angle determination device is mounted on top of a tower. The towers are positioned a distance from each other. Each angle determination device is adapted to automatically determine the angle of incident of a received signal and transmit a determined angle signal containing the determined angle. The location determination device is adapted to automatically use spatial triangulation techniques on received determined angle signals to provide location information.

In another embodiment, a location determination device is provided. The device includes a signal generator, a transmitter, a receiver and a triangulation module. The signal generator is adapted to generate location signals. The transmitter is adapted to transmit the location signals. The receiver is adapted to receive determined angle signals from angle determination devices mount on towers and The triangulation module is adapted to automatically apply triangulation techniques on two or more received determined angle signals to determine the location of the location determination device.

In yet another embodiment, a method of determining geo-location of an object is provided. The method comprises transmitting signals from a location determination device to two or more angle determination devices, wherein the two or more angle determination devices are located in different locations and are mounted on respective towers. Automatically determining the angle of incident of each received signal with the two or more angle determination devices. Transmitting determined angle signals back to the location determination device and determining the location of the location determination device based on at least two received determined angle signals.

In still another embodiment, a geo-location system is provided. The system includes a means to generate location signals from the desired position to be located. A means to receive the location signals at different locations in relation to the position to be located. A means to determine the angle of incidence of received location signals. A means to transmit the determined angles in determined angle signals back to the desired position to be located and a means to automatically determine the position based on at least two received determined angle signals.

In finally another embodiment, a method of determining geo-location is provided. The method comprises incrementally deploying an infrastructure of angle determining devices. Each angle determination device is mounted on a tower, wherein the towers are spaced select distances from each other. Determining the angle of incident of signals from a location determination device with one or more angle determination device automatically upon detection of the signal and using automated special triangulation techniques on determined angles of incidents of the signals to provide location information.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a geo-location system of one embodiment of the present invention;

FIG. 2 is a flow diagram of one embodiment of the present invention;

FIG. 3 is a geo-location system illustrating accuracy of one embodiment of the present invention;

FIG. 4 is geo-location system of another embodiment of the present invention;

FIG. 5 is a flow diagram of one embodiment of the present invention; and

FIG. 6 is a block diagram of a location determination device of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide a geo-location system that is relatively easy to construct and use. In one embodiment, the navigation system includes at least two towers. On top of each tower is an angle determination device that determines the angle of a received signal and transmits a determined angle signal. This system also includes a location determination device. The location determination device uses triangulation methods to determine location when at least two different determined angle signals are received.

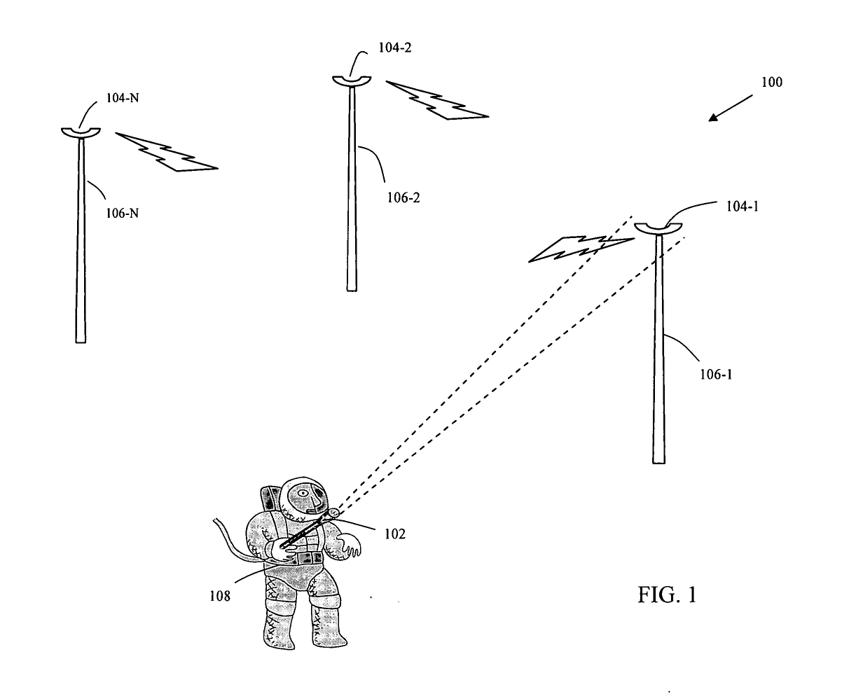

Referring to FIG. 1, one embodiment of a geo-location system 100 of the present invention is illustrated. As illustrated, the location system 100 includes towers 106-1 through 106-N. In particular, in embodiments of the present application that determine geo-locations, at least two towers (or poles) that are spaced a distance away from each other is required. On the top of each tower 106-1 though 106-N is a direction determining device 104-1 through 104-N. In one embodiment, at least one of the direction determining devices 104-1 through 104-N is a laser detection and reciprocal targeting (LDART) device. An Example of an LDART device is illustrated in a commonly assigned Patent Application having docket number H0005753 which is herein incorporated by reference. Also illustrated in FIG. 1, is an astronaut 108 desiring a geo-location be taken so that his or her exact location can be determined. The astronaut 108 in this embodiment is holding a location determining device 102. The location determination device 102 is directed to send a location signal to at least two of the direction determination devices 104-1 through 104-2 in this embodiment.

Each direction determination device, 104-1 through 104-N, determines the angle of incident of the respective received location signal and sends a determined angle signal back to the location determination device 102. The location determination device 102 then uses triangulation techniques known in the art on the received determined angle signals to determine the geo-location of the object or astronaut 108 in this example.

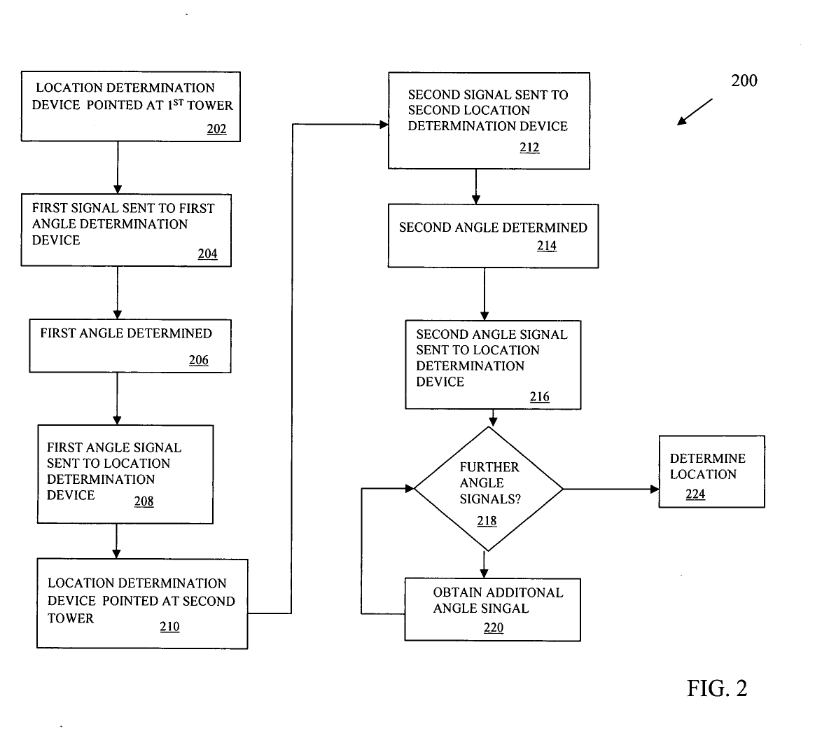

FIG. 2 is a location determination flow chart 200 of one embodiment of the present invention. The flow chart 200 is described in light of the geo-location system 100 of FIG. 1. As illustrated in FIG. 200, a location determination starts by pointing a location determination device 102 at a first angle determination device 104-1 on a first tower 106-1 (202). A first location signal is then sent to the first angle determination device 104-1 (204). In one embodiment this is accomplished by depressing an activation button while pointing the location activation device 102 at the angle determination device 104-1. The first angle determination device 104-1 then determines a first relative angle of the received first location signal (206) and sends a first determined angle signal back to the location determination device 102 (208). The location determination device 102 is then pointed at a second angle determination device 104-2 on a second tower 106-2 (210). The second tower 106-2 is located at a different location than the first tower 106-1. A second location signal is then send to the second angle determination device 104-2 by the location determination device 102 (212) The second angle determination device 104-2 than determines a second relative angle of the received second signal (214) and sends a second determined angle back to the location determination device 102 (216).

In the embodiment of FIG. 2, it is then determined if further angle signals from additional angle determination devices are desired (218). The more angles determined from different towers the more accurate a geo-location determination. If no further angles signals are required (or available) (218), the location of the astronaut is determined by triangulation means known in the art (224). If further determined angle signals are desired and available (218), the additional determined angle signals are obtained (220). Once it is determined that enough angle signals have been received (218), the geo-location of the location determination device is determined (224).

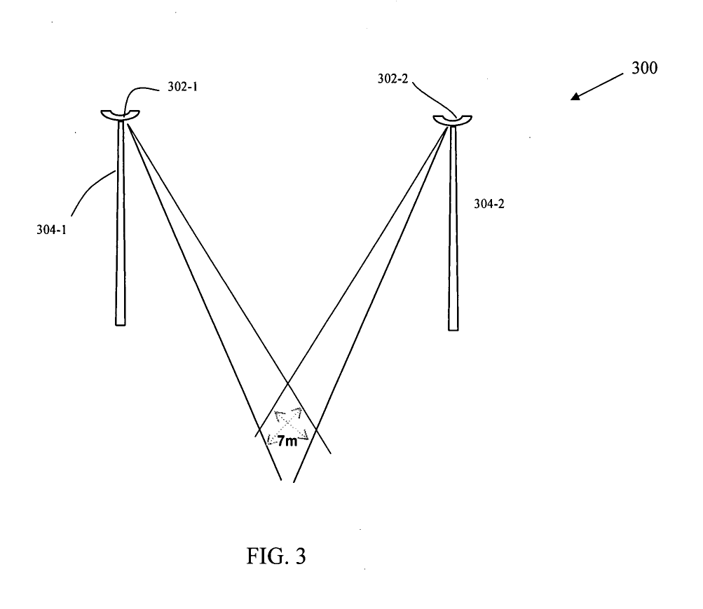

As indicated above, the accuracy of a determined geo-location is dependent on the number of determined angle signals received from respective towers. An example of an area of accuracy with the use of two determined angle signals from two angle determination devices is illustrated in FIG. 3. In this example, the object, in which a location relating to the towers is desired, is approximately 2 km away from each of the towers 304-1 and 302-2. In this example, a location uncertainty area 306 is formed in the shape of a trapezoid having a distance of approximately 7 m across.

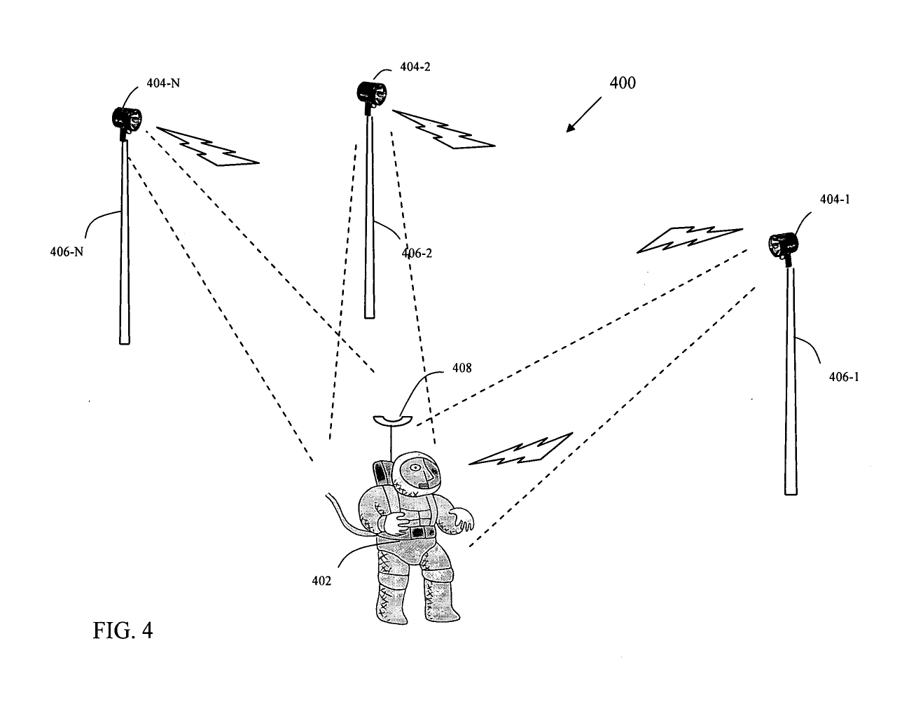

Another embodiment of a geo-location system 400 of the present invention is illustrated in FIG. 4. In this embodiment, each tower 406-1 through 104-N has an angle determination device 404-1 through 404-N respectively mounted thereon. Each angle determination device 404-1 through 404-N in this embodiment produces seeking signals that are rotated (or scanned) in different directions. In one embodiment the signals are laser signals. As illustrated in FIG. 4, an astronaut 402 has a location detection device 408. The location detector device 408 of this embodiment senses signals that are directed at it from the signal generating devices 404-1 through 404-N and acknowledges the receipt of a seeking signal by sending a location signal (or return signal) back to the associated angle determination device 404-1 through 404-N. The associated angle determination device 404-1 through 404-N then determines the angle of incident of the location signal. A determined angle signal is then transmitted to the location determination device 408. The location determination device 408 then computes the location once two or more angle signals have been received from two different angle determination devices 404-1 through 404-N on associated towers 406-1 through 406-N.

In one embodiment, when a scanning laser (angle determining device 404-1 through 404-N) receives confirmation that that the sensor (the location detection device (408) has been painted, the scanning laser uses this transmission to approximate the angle at which the laser was pointing. In this embodiment, the process is repeated a select number of times to allow the angle determination to be improved by the process of averaging and bounding the angle range which results in painting the sensor.

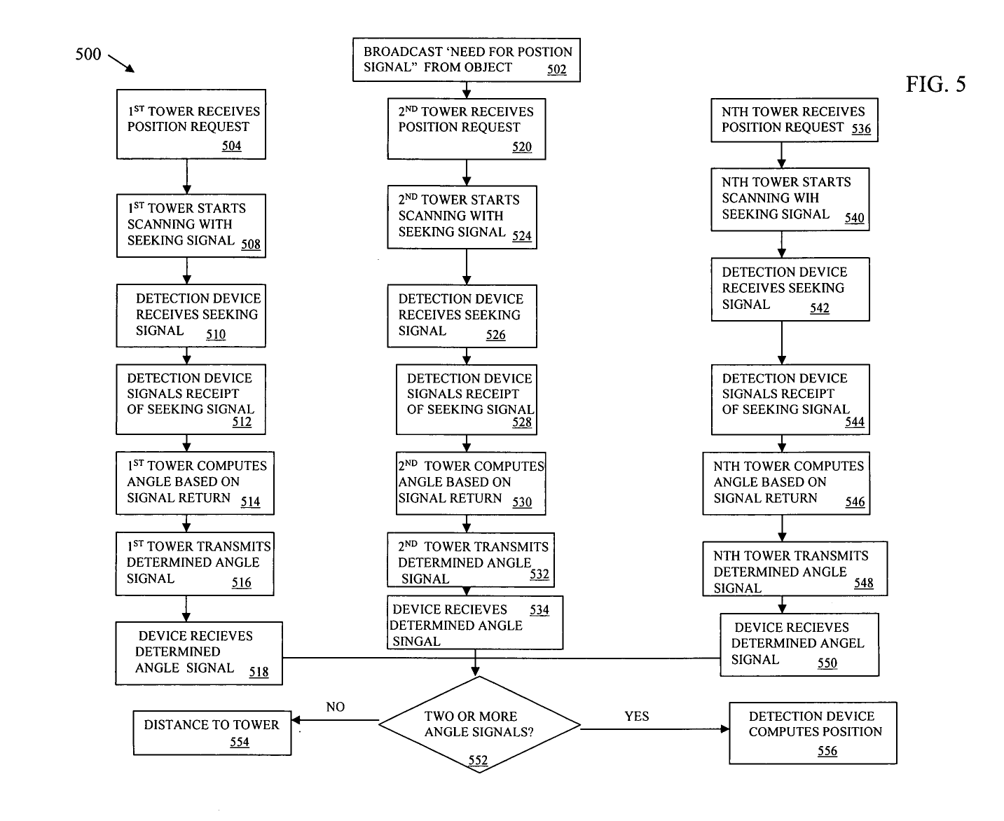

Referring to FIG. 5, a location flow chart 500 of an embodiment of the present invention is illustrated. The location flow chart 500 is herein described in light of the geo-location system 400 illustrated in FIG. 4. As the geo-location flow chart 500 illustrates, the location determination device 408 initiates a geo-location determination by sending a need for position signal (or initial signal) (502). The angle determination devices 404-1 through 404-N that are within a range of location determination device 408 receive the initial signal (504), (520) and (536). Once, the angle determination devices 404-1 through 404-N receive the need for position signal, the respective tower (i.e. the angle determination device 404-1 through 404-N on the tower) starts scanning with a seeking signal (508), (524) and (540). As the seeking signals are scanned in different directions, one or more seeking signals will be incident upon and received by the location determination device 408 (510), (526) and (542). In response to receiving the seeking signals, the location determination device 408 provides a return signal (or location signal) (512), (528) and (544). Each angle determination device 404-1 through 404-N that receives the location signal, computes the angle of incident of the received location signal (514, (530) and (545). In one embodiment, the process of sending seeking signals and sending return signals is repeated for a select number of times to determine an average determined angle signal. The determined angle signal is then sent back to the detecting device (516), (532) and (548). The location determination device 408 then receives the determined angle signal (518), (534) and (550).

When a determined angle signal is received (518), (534) and (550) by the location determination device 408, the location determination device 408 determines if two or more determined angle signals have been received (552). If two or more determined angle signals have been received (552), the location determination device determines the geo-location via triangulation methods (556). If only one directional signal has been received (552), the distance to the tower containing the angle determination device 404-1 through 404-N that sent the determined angle signal is determined.

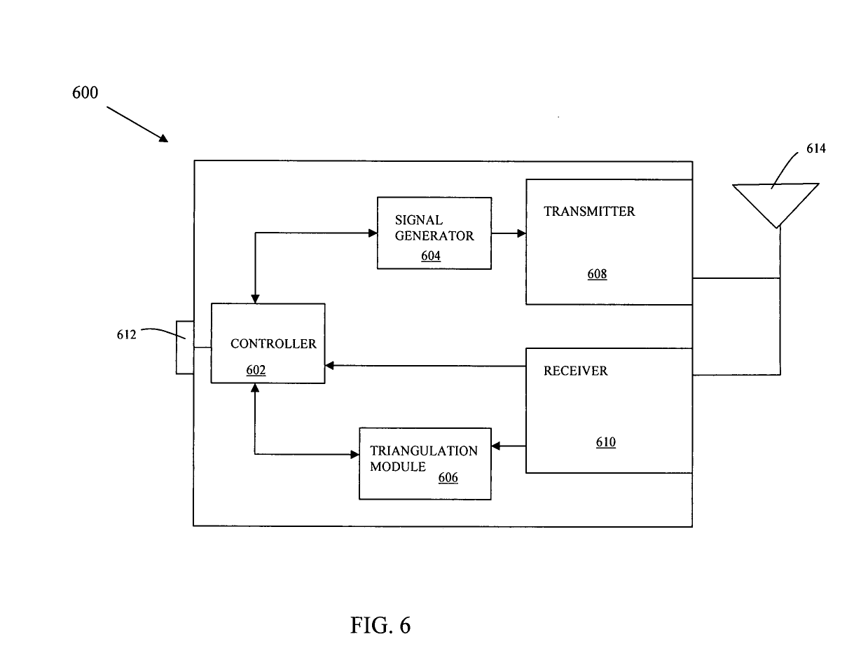

Referring to FIG. 6, a block diagram of a location determination device 600 of one embodiment of the present invention is illustrated. The location determination device 600 of this embodiment includes a controller 602, a signal generator 604, a triangulation module 606, a transmitter 608, a receiver 610, an activation control 612 and an antenna 614. The controller 602 controls the functions of the location determination device 600. The controller 602 receives commands via the activation control 612 which is manipulated by a user. In one embodiment, the activation control 612 is a button that is depressed to activate the location determination device 600. The signal generator 604 generates signals such as the location signal as well as the initial signals for the embodiments illustrated in FIGS. 4 and 5. The transmitter 608 transmits the generated signals via the antenna 614. The receiver receives signals, such as the determined angle signals as well as the scanning signals of embodiments illustrated in FIGS. 4 and 5, through the antenna 614. The triangulation module 606 computes the location of the location determination device 600 based on the received determined angle signals and in one embodiment the distance to a tower from a single received determined angle signal.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A geo-location system comprising:
two or more angle determination devices, each angle determination device being mounted on top of a tower, wherein the towers are positioned a distance from each other, each angle determination device is adapted to automatically determine the angle of incident of a received signal and transmit a determined angle signal containing the determined angle; and
a location determination device adapted to automatically use spatial triangulation techniques on received determined angle signals to provide location information.

2. The geo-location system of claim 1, wherein at least one of the two or more angle determination devices is a laser detection and reciprocal targeting (LDART) device.

3. The geo-location system of claim 1, wherein the angle determination device is further adapted to determine the approximate distance to a tower based on the angle of a received signal.

4. The geo-location device of claim 1, wherein the location determination device is further adapted to transmit signals to the two or more angle determining devices.

5. The geo-location device of claim 1, wherein at least one of the two or more angle determination devices is further adapted to transmit laser signals in different directions.

6. The geo-location device of claim 5, wherein the location determination device is further adapted to transmit an acknowledgement signal when a laser signal from an angle determination device is received.

7. A location determination device, the device comprising:
a signal generator adapted to generate location signals;
a transmitter adapted to transmit the location signals;
a receiver adapted to receive determined angle signals from angle determination devices mounted on towers; and
a triangulation module adapted to automatically apply triangulation techniques on two or more received determined angle signals to determine the location of the location determination device.

8. The device of claim 7, further comprising:
a controller adapted to control the signal generator and the triangulation module; and
an activation control adapted to interface commands to the controller.

9. The device of claim 7, further comprising:
an antenna to transmit and receive signals, the antenna in communication with the transmitter and receiver.

10. A method of determining geo-location of an object, the method comprising:
transmitting signals from a location determination device to two or more angle determination devices, wherein the two or more angle determination devices are located in different locations and are mounted on respective towers;
automatically determining the angle of incident of each received signal with the two or more angle determination devices;
transmitting determined angle signals back to the location determination device; and
determining the location of the location determination device based on at least two received determined angle signals.

11. The method of claim 10, further comprising:
determining the approximate distance between the location determination device and a tower based on a received signal.

12. The method of claim 10, wherein determining the location of the location determination device based on at least two received determined angle signals further comprises:
using triangulation techniques on the at least two received determined angle signals.

13. The method of claim 10, further comprising:
transmitting laser signals in different directions from each angle determination device; and
transmitting the signals from the location determination device when each laser signal is incident upon the location determination device.

14. The method of claim 13, further comprising:
transmitting an initial signal from the location determination device to initiate the transmission of laser signals in different directions from each angle determination device.

15. a geo-location system, the system comprising:
a means to generate location signals from the desired position to be located;
a means to receive the location signals at different locations in relation to the position to be located;
a means to determine the angle of incident of received location signals;
a means to transmit the determined angles in determined angle signals back to the desired position to be located; and
a means to automatically determine the position based on at least two received determined angle signals.

16. The system of claim 15, further comprising:
a means to initiate the scanning of seeking signals from angle determination devices mounted on towers; and
a means of producing seeking signals in response to the means to initiate the scanning.

17. The system of claim 15, further comprising:
a means to determine the distance to a tower based on a single received determined angle signal.

18. A method of determining geo-location, the method comprising:
incrementally deploying an infrastructure of angle determining devices, each angle determination device mounted on a tower, wherein the towers are spaced select distances from each other;
determining the angle of incident of signals from a location determination device with one or more angle determination device automatically upon detection of the signal; and
using automated special triangulation techniques on determined angles of incidents of the signals to provide location information.

19. The method of claim 18, wherein determining the angle of incident further comprises:
receiving two or more signals from the location determination device;
determining the angle of incident of each of the received signals; and
averaging the angle of incident of each received signal.

20. The method of claim 18, wherein the determining the angle of incident further comprises:
receiving a first signal from the location determination device;
bounding the range of seeking signals from a respective angle determination device based on the received first signal;
receiving one or more subsequent signals in response to seeking signals; and
averaging of the angle of incident of the first and one or more subsequent signals.
